(19) United States
(12) Patent Application Publication
(10) Pub. No.: US 2013/0112651 A1
(43) Pub. Date: May 9, 2013

(54) METHOD FOR MANUFACTURING COIL PARTS

(71) Applicant: SAMSUNG ELECTRO-MECHANICS CO., LTD., Gyeonggi-do (KR)

(72) Inventors: Sang Moon LEE, Seoul (KR); Sung Kwon WI, Seoul (KR); Jeong Bok KWAK, Gyeonggi-do (KR); Young Seuck YOO, Seoul (KR); Yong Suk KIM, Gyeonggi-do (KR)

(73) Assignee: SAMSUNG ELECTRO-MECHANICS CO., LTD., Gyeonggi-do (KR)

(21) Appl. No.: 13/670,991

(22) Filed: Nov. 7, 2012

(30) Foreign Application Priority Data
Nov. 7, 2011 (KR) 10-2011-0115191

(51) Int. Cl. H01F 41/04

(52) U.S. Cl. CPC H01F 41/04
USPC 216/13

(57) ABSTRACT

The present invention discloses a method for manufacturing coil parts including a ferrite substrate, a conductor line formed on the ferrite substrate, and an external electrode for external electrical connection of the conductor line, including: coating a magnetic layer to cover the external electrode; planarizing a surface of the magnetic layer by mechanical polishing so that a portion of the magnetic layer remains on the external electrode; and exposing the external electrode by removing the remaining magnetic layer by chemical polishing.

According to the present invention, it is possible to reduce planarization process time and cost by simplifying a process of planarizing the magnetic layer and improve productivity and reliability of products by preventing stress and damage to the external electrode occurred in the planarization process.

### CROSS-REFERENCE TO RELATED APPLICATIONS

Claim and incorporate by reference domestic priority application and foreign priority application as follows:

### Cross Reference to Related Application

This application claims the benefit under 35 U.S.C. Section 119 of Korean Patent Application Serial No. 10-2011-0115191, entitled filed Nov. 7, 2011, which is hereby incorporated by reference in its entirety into this application.

### BACKGROUND OF THE INVENTION

1. Field of the Invention

The present invention relates to a method for manufacturing coil parts, and more particularly, to a method for manufacturing coil parts that can improve productivity of coil parts and reduce manufacturing costs by simplifying a planarization process of a magnetic layer.

2. Description of the Related Art

In the late 1980s, IBM of the United States developed a new polishing process called chemical mechanical polishing (CMP), where mechanical processing and chemical processing are combined into a single processing method, as a processing method of planarizing the surface of a substrate such as a wafer, which is one of semiconductor manufacturing processes.

The CMP is a process positively necessary for fabrication of a chip on a submicron scale and has to be continuously applied to the entire surface of a device layer. The CMP has a main role of widely planarizing each layer to obtain a three-dimensional shape. The CMP is a polishing process in which a mechanical action and a chemical action are conducted at the same time to interact with each other.

More specifically, as shown in FIG. 1, in the CMP process, a wafer 1 to be planarized is polished by a pad 2 and slurry 3. A polishing table (not shown) to which the pad 2 is attached simply rotates, and a head portion presses the wafer 1 with a predetermined pressure while performing rotation and shaking at the same time.

That is, the wafer 1 is mounted to the head portion by surface tension or vacuum. The surface of the wafer 1 and the pad 2 are brought into contact with each other by a self load of the head portion and the applied pressure. The slurry 3, which is a processing liquid, flows between a fine gap (pore portion of the pad) between contact surfaces so that mechanical removal is performed by polishing particles in the slurry 3 and surface protrusions of the pad 2 and chemical removal is performed at the same time by chemical components in the slurry 3.

In the CMP process, the pressure between the pad 2 and the wafer 3 causes the contact at the top of a protrusion of a device, and the portion to which pressure is exclusively applied has a relatively high surface removal speed. As the process continues, the protrusion is lowered and the entire area is uniformly planarized.

However, the CMP process has a low polishing speed, is an expensive process, and is not suitable for a large-area planarization process in terms of speed and cost.

Therefore, when applied to a planarization process of coil parts for removing noise such as a common mode filter, there are many problems such as a considerable increase in manufacturing costs of the coil parts, an increase in process time due to a low polishing speed, and damage to an electrode received in a planarization layer in addition to the planarization layer due to a difficulty in adjusting a polishing thickness of the layer to be planarized of the coil parts when the degree of polishing is severe.

### SUMMARY OF THE INVENTION

The present invention has been invented in order to overcome the above-described problems and it is, therefore, an object of the present invention to provide a method for manufacturing coil parts that can improve productivity of coil parts and reduce manufacturing costs by simplifying a planarization process of the coil parts to reduce the time required for the planarization process.

It is another object of the present invention to provide a method for manufacturing coil parts that can minimize a failure rate of products and improve reliability of the products by preventing damage and concentration of stress on an electrode received in a planarization target in a planarization process of coil parts.

In accordance with one aspect of the present invention to achieve the object, there is provided a method for manufacturing coil parts including a ferrite substrate, a conductor line formed on the ferrite substrate, and an external electrode for external electrical connection of the conductor line, including: coating a magnetic layer to cover the external electrode; planarizing a surface of the magnetic layer by mechanical polishing so that a portion of the magnetic layer remains on the external electrode; and exposing the external electrode by removing the remaining magnetic layer by chemical polishing.

Here, the magnetic layer, which remains on the external electrode by the mechanical polishing, may have a thickness of 1 to 2 μm from a surface of the external electrode.

And, the mechanical polishing may be performed by rotating at least one of a ceramic buff and a brush buff to polish the surface of the magnetic layer.

At this time, the rotation may be performed at a speed of 1800 RPM.

Meanwhile, the chemical polishing may be performed by dipping the remaining magnetic layer in an etching solution.

At this time, the dipping may be performed for 10 to 30 minutes.

Further, the etching solution may include potassium permanganate.

Meanwhile, the magnetic layer may be made of ferrite and a composite material comprising any one polymer material of epoxy and polyimide.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a configuration diagram for explaining a wafer planarization process in a conventional chip manufacturing process;

FIG. 2 is a flowchart schematically showing an embodiment of a method for manufacturing coil parts in accordance with the present invention; and

FIGS. 3a to 3f are process cross-sectional views for explaining an embodiment of the method for manufacturing coil parts in accordance with the present invention, wherein

FIG. 3a is a cross-sectional view schematically showing the state in which a magnetic layer is coated,

FIG. 3b is a plan view of FIG. 3a,

FIG. 3c is a cross-sectional view schematically showing that a surface of the magnetic layer is planarized by mechanical polishing,

FIG. 3d is a cross-sectional view schematically showing that the surface of the magnetic layer is planarized by mechanical polishing,

FIG. 3e is a cross-sectional view schematically showing the state in which a planarization process of the magnetic layer is completed, and

FIG. 3f is a plan view of FIG. 3e.

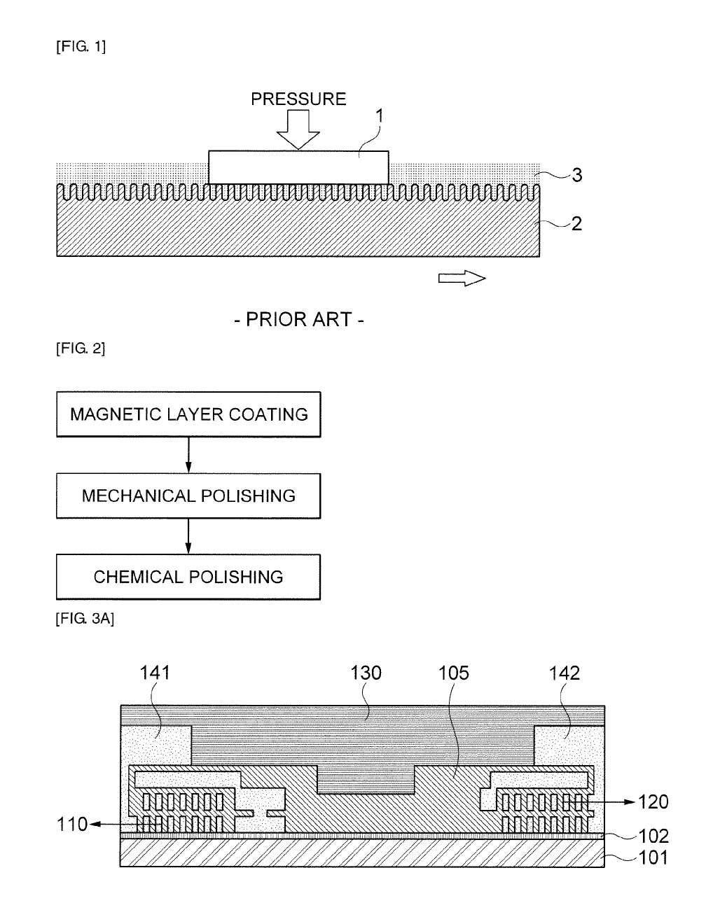

### DETAILED DESCRIPTION OF THE PREFERABLE EMBODIMENTS

Advantages and features of the present invention and methods of accomplishing the same will be apparent by referring to embodiments described below in detail in connection with the accompanying drawings. However, the present invention is not limited to the embodiments disclosed below and may be implemented in various different forms. The exemplary embodiments are provided only for completing the disclosure of the present invention and for fully representing the scope of the present invention to those skilled in the art. Like reference numerals refer to like elements throughout the specification.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Further, embodiments to be described throughout the specification will be described with reference to cross-sectional views and/or plan views, which are ideal exemplary drawings of the present invention. In the drawings, the thicknesses of layers and regions may be exaggerated for the effective explanation of technical contents. Therefore, the exemplary drawings may be modified by manufacturing techniques and/or tolerances. Therefore, the embodiments of the present invention are not limited to the accompanying drawings, and can include modifications to be generated according to manufacturing processes. For example, an etched region shown at a right angle may be formed in the rounded shape or formed to have a predetermined curvature. Therefore, regions shown in the drawings have schematic characteristics. In addition, the shapes of the regions shown in the drawings exemplify specific shapes of regions in an element, and do not limit the invention.

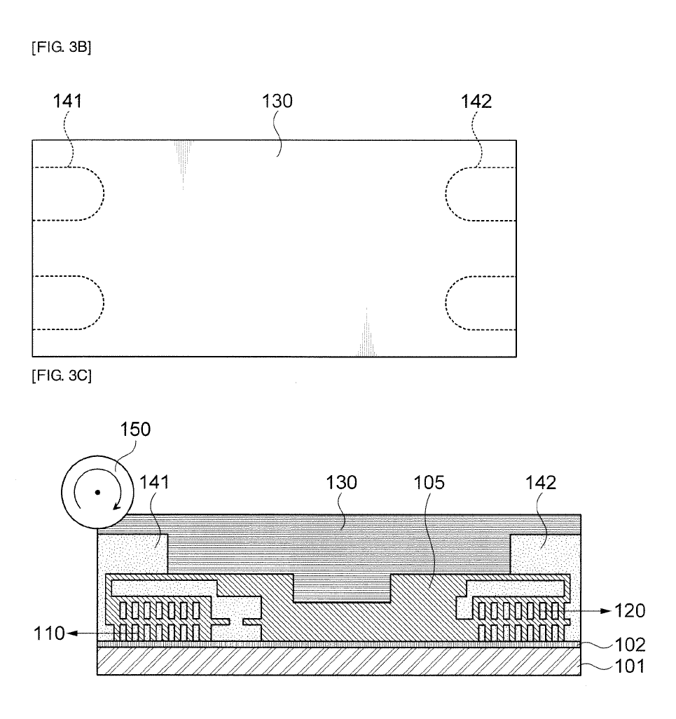

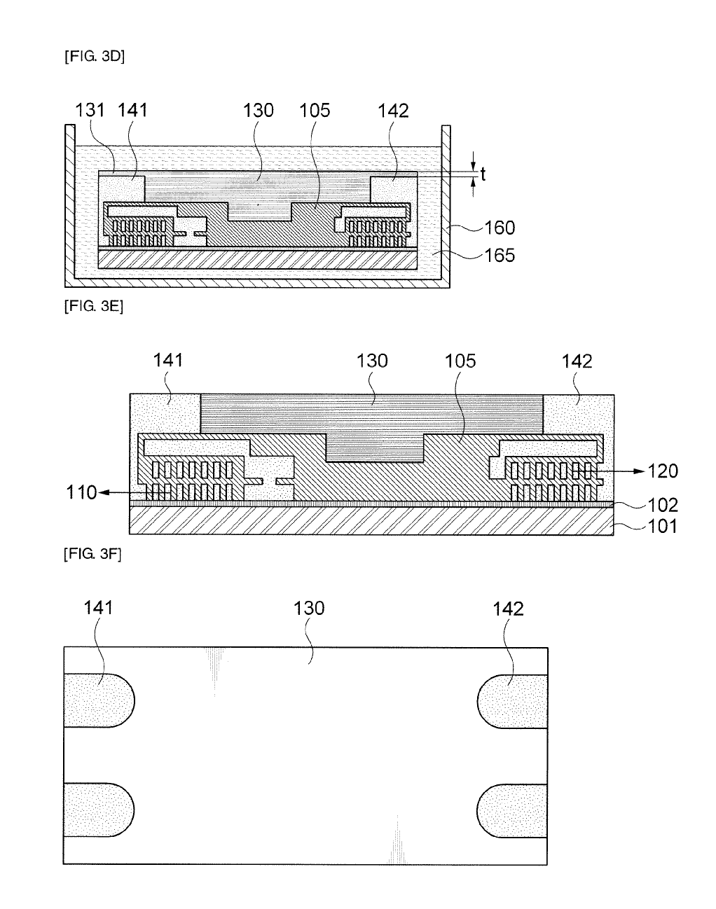

Hereinafter, an embodiment of a method for manufacturing coil parts in accordance with the present invention will be described in detail with reference to FIGS. 2 to 3f.

FIG. 2 is a flowchart schematically showing an embodiment of a method for manufacturing coil parts in accordance with the present invention, and FIGS. 3a to 3f are process cross-sectional views for explaining an embodiment of the method for manufacturing coil parts in accordance with the present invention, wherein FIG. 3a is a cross-sectional view schematically showing the state in which a magnetic layer is coated, FIG. 3b is a plan view of FIG. 3a, FIG. 3c is a cross-sectional view schematically showing that a surface of the magnetic layer is planarized by mechanical polishing, FIG. 3d is a cross-sectional view schematically showing that the surface of the magnetic layer is planarized by mechanical polishing, FIG. 3e is a cross-sectional view schematically showing the state in which a planarization process of the magnetic layer is completed, and FIG. 3f is a plan view of FIG. 3e.

Referring to FIG. 2, an embodiment of a method for manufacturing coil parts in accordance with the present invention may include a magnetic layer coating step, a mechanical polishing step, and a chemical polishing step.

More specifically, as shown in FIG. 3a, after an insulating layer 102 is formed on an upper surface of a ferrite substrate 101, a first conductor line 110 and a second conductor line 120 are formed on the ferrite substrate 101 by a thin-film process and so on.

At this time, the first conductor line 110 and the second conductor line 120 may be formed to be electrically separated from each other by a photoresist layer 105 formed in a thin-film process.

And, a first external electrode 141 for external electrical connection of the first conductor line 110 and a second external electrode 142 for external electrical connection of the second conductor line 120 are formed by a thin-film process and so on.

After that, as shown in FIG. 3b, a magnetic layer 130 is coated to cover the first external electrode 141, the second external electrode 142, and the insulating layer 105.

That is, since the magnetic layer 130 is filled in an injection manner and coated, the magnetic layer 130 is formed to cover the first external electrode 141 and the second external electrode 142.

At this time, the magnetic layer 130 may be made of a composite material including any one polymer material of epoxy and polyimide in addition to ferrite for improvement of adhesion.

Next, a planarization process is performed to expose upper surfaces of the first external electrode 141 and the second external electrode 142 and planarize a surface of the magnetic layer 130.

First, as shown in FIG. 3c, a first planarization process is performed to planarize the surface of the magnetic layer 130 by mechanical polishing.

Here, the mechanical polishing is performed so that a portion of the magnetic layer 130 remains on the upper surfaces of the first external electrode 141 and the second external electrode 142 to prevent the first external electrode 141 and the second external electrode 142 from being stressed or damaged in the planarization process using the mechanical polishing.

And, the mechanical polishing may be performed by rotating at least one polishing member 150 of a ceramic buff and a brush buff to polish the surface of the magnetic layer 130 or by combining the ceramic buff and the brush buff. In addition, the mechanical polishing may be performed by a polishing member such as a sand belt.

At this time, the rotation members for mechanical polishing such as the ceramic buff and the brush buff may rotate at a speed of 1800 RPM but not limited thereto.

Further, in the planarization process using the mechanical polishing, the magnetic layer 131 remaining on the first external electrode 141 and the second external electrode 142 may remain with a thickness (t) of 1 to 2 μm from the surface of each external electrode 141 and 142 but not limited thereto.

Next, as shown in FIG. 3d, a second planarization process is performed to remove the magnetic layer 131 remaining on the upper surface of the first external electrode 141 and the upper surface of the second external electrode 142 by chemical polishing to expose the upper surface of the first external electrode 141 and the upper surface of the second external electrode 142.

That is, the coil part passing through the planarization process using the mechanical polishing is dipped in an etching solution 165 received in a polishing vessel 160 to remove the magnetic layer 131 remaining on the upper surface of the first external electrode 141 and the upper surface of the second external electrode 142. Accordingly, as shown in FIGS. 3e and 3f, the upper surface of the first external electrode 141 and the upper surface of the second external electrode 142 are exposed and the surface of the magnetic layer 130 becomes a polished flat surface by a chemical treatment at the same time.

Here, the dipping of the coil part may be performed for 10 to 30 minutes.

Further, the etching solution may be solutions such as strong acid, strong alkali, and an oxidizing agent, and the present embodiment discloses potassium permanganate as a sort of the etching solution.

As described above, according to the stamp for manufacturing a conductor line and a via and the method for manufacturing a coil part using the same in accordance with the present invention, it is possible to improve manufacturing processability.

According to the method for manufacturing coil parts in accordance with the present invention, it is possible to reduce planarization process time and cost by simplifying the process of planarizing the magnetic layer and improve the productivity and reliability of the products by preventing the stress and damage to the external electrode occurred in the planarization process.

Further, according to the stamp for manufacturing a conductor line and a via and the method for manufacturing a coil part using the same in accordance with the present invention, it is possible to improve productivity and reduce manufacturing costs by preventing defects occurred when performing a thin-film process on a conventional ferrite substrate.

The foregoing description illustrates the present invention. Additionally, the foregoing description shows and explains only the preferred embodiments of the present invention, but it is to be understood that the present invention is capable of use in various other combinations, modifications, and environments and is capable of changes and modifications within the scope of the inventive concept as expressed herein, commensurate with the above teachings and/or the skill or knowledge of the related art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

1. A method for manufacturing coil parts comprising a ferrite substrate, a conductor line formed on the ferrite substrate, and an external electrode for external electrical connection of the conductor line, comprising:
coating a magnetic layer to cover the external electrode;
planarizing a surface of the magnetic layer by mechanical polishing so that a portion of the magnetic layer remains on the external electrode; and
exposing the external electrode by removing the remaining magnetic layer by chemical polishing .

2. The method for manufacturing coil parts according to claim 1, wherein the magnetic layer, which remains on the external electrode by the mechanical polishing, has a thickness of 1 to 2 μm from a surface of the external electrode.

3. The method for manufacturing coil parts according to claim 1, wherein the mechanical polishing is performed by rotating at least one of a ceramic buff and a brush buff to polish the surface of the magnetic layer.

4. The method for manufacturing coil parts according to claim 3, wherein the rotation is performed at a speed of 1800 RPM.

5. The method for manufacturing coil parts according to claim 1, wherein the chemical polishing is performed by dipping the remaining magnetic layer in an etching solution.

6. The method for manufacturing coil parts according to claim 5, wherein the dipping is performed for 10 to 30 minutes.

7. The method for manufacturing coil parts according to claim 5, wherein the etching solution comprises potassium permanganate.

8. The method for manufacturing coil parts according to claim 1, wherein the magnetic layer is made of ferrite and a composite material comprising any one polymer material of epoxy and polyimide.

9. The method for manufacturing coil parts according to claim 2, wherein the mechanical polishing is performed by rotating at least one of a ceramic buff and a brush buff to polish the surface of the magnetic layer.

10. The method for manufacturing coil parts according to claim 6, wherein the etching solution comprises potassium permanganate.
